(19) United States
(12) Patent Application Publication
(10) Pub. No.: US 2018/0358729 A1
(43) Pub. Date: Dec. 13, 2018

(54) ELECTRICAL CONNECTOR HAVING INTERCONNECTED POWER CONTACT AND ADJACENT HOLDING MEMBER

(71) Applicant: FOXCONN INTERCONNECT TECHNOLOGY LIMITED, Grand Cayman (KY)

(72) Inventor: MING-CHING CHEN, New Taipei (TW)

(21) Appl. No.: 16/003,444

(22) Filed: Jun. 8, 2018

(30) Foreign Application Priority Data
Jun. 8, 2017 (CN) 201720663926.8

(51) Int. Cl. H01R 13/20; H01R 12/71

(52) U.S. Cl. CPC H01R 13/20; H01R 12/716

(57) ABSTRACT

An electrical connector includes: an insulative housing defining a receiving space; plural signal contacts secured to the insulative housing and exposed to the receiving space; a pair of holding members secured to two opposite ends of the insulative housing and exposed to the receiving space, each holding member having a base and a pair of arms bent from the base; and plural power contacts secured to the insulative housing, exposed to the receiving space, and disposed adjacent to the pair of holding members, wherein the pair of holding members act as power contacts, and the pair of arms of each holding member are integrally connected to adjacent power contacts.

### BACKGROUND OF THE INVENTION

### 1. Field of the Invention

The present invention relates to an electrical connector having power contacts and holding members also acting as power contacts and more particularly to a structure of adjacent power contacts and holding members that are interconnected to decrease temperature rise in conducting large current.

### 2. Description of Related Art

U.S. Pat. No. 7,901,218 discloses an electrical connector including first and second fixtures each having at least three engaging or anchoring portions, respectively, that are engaged and therefore caused to be in electrical continuity, thereby using as power supply terminal.

U.S. Pat. No. 9,356,371 discloses a connector including wide terminals that can be connected to power lines and narrow terminals that can be connected to signal lines. The wide terminals are present on both sides of connector housing in longitudinal direction, heat is readily dissipated and does not build up inside the connector.

It is also known to provide an electrical connector of the above board-to-board type that has separate power contacts and holding members with the latter also acting as power contacts. The holding members are located at two opposite ends of an insulative housing of the connector and each may be a one-piece element or made of two parts.

### SUMMARY OF THE INVENTION

An electrical connector comprises: an insulative housing defining a receiving space; a plurality of signal contacts secured to the insulative housing and exposed to the receiving space; a pair of holding members secured to two opposite ends of the insulative housing and exposed to the receiving space, each holding member having a base and a pair of arms bent from the base; and a plurality of power contacts secured to the insulative housing, exposed to the receiving space, and disposed adjacent to the pair of holding members, wherein the pair of holding members act as power contacts, and the pair of arms of each holding member are integrally connected to adjacent power contacts.

### BRIEF DESCRIPTION OF THE DRAWINGS

FIG. 1 is a perspective view of an electrical connector assembly in accordance with the present invention;

FIG. 2 is another perspective view of the electrical connector assembly;

FIG. 3 is a perspective view of a plug connector and a receptacle connector of the electrical connector assembly;

FIG. 4 is another perspective view of the plug connector and the receptacle connector;

FIG. 5 is an exploded view of the plug connector;

FIG. 6 is another exploded view of the plug connector;

FIG. 7 is an exploded view of the receptacle connector;

FIG. 8 is another exploded view of the receptacle connector;

FIG. 9 is a cross-sectional view of the receptacle connector and the plug connector before assembling;

FIG. 10 is a cross-sectional view of the receptacle connector and the plug connector after assembling;

FIG. 11 is a cross-sectional view of the receptacle connector and the plug connector taken along a line passing through two holding members thereof; and

FIG. 12 is another cross-sectional view of the receptacle connector and the plug connector taken along another line passing through the two holding members.

### DETAILED DESCRIPTION OF THE PREFERRED EMBODIMENT

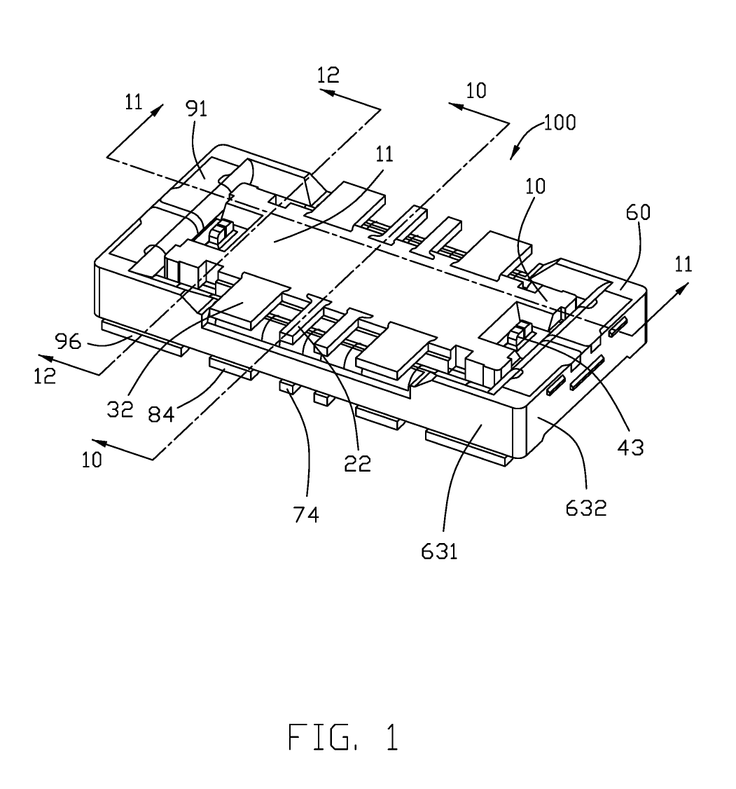

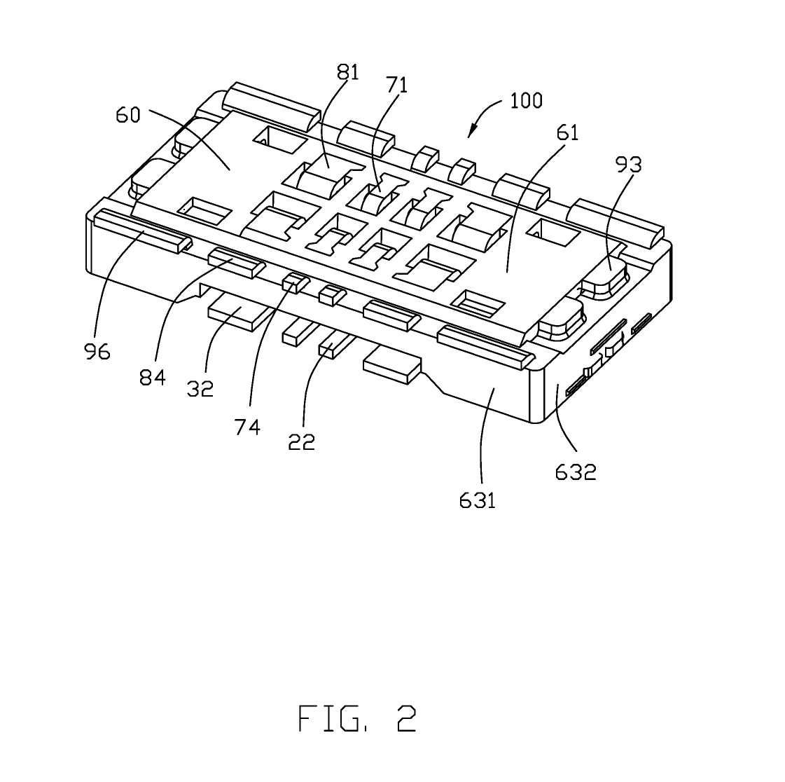

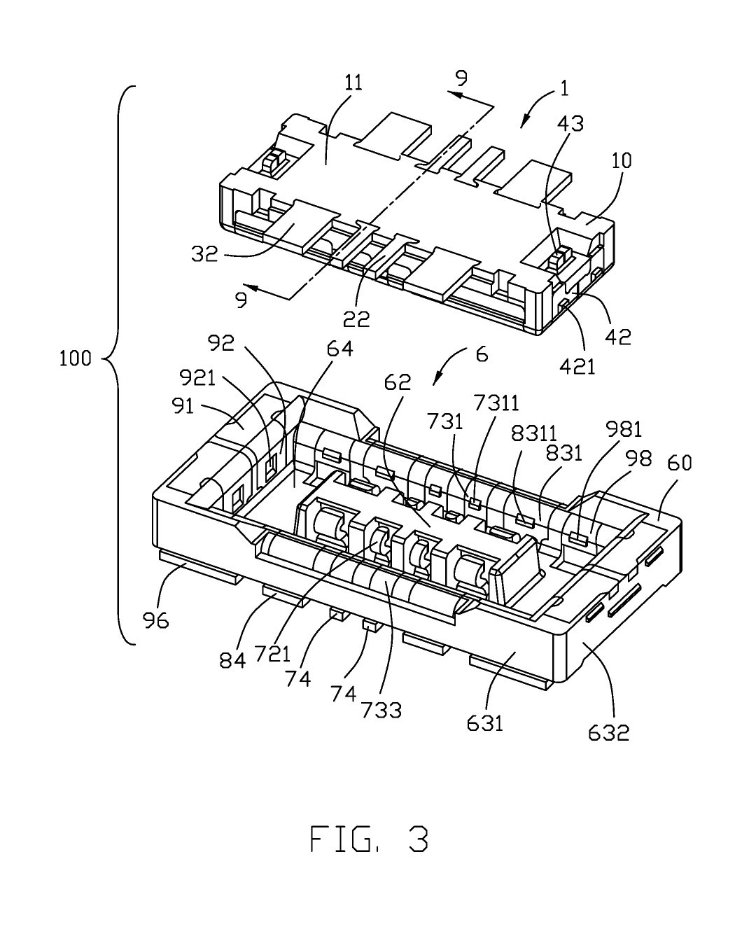

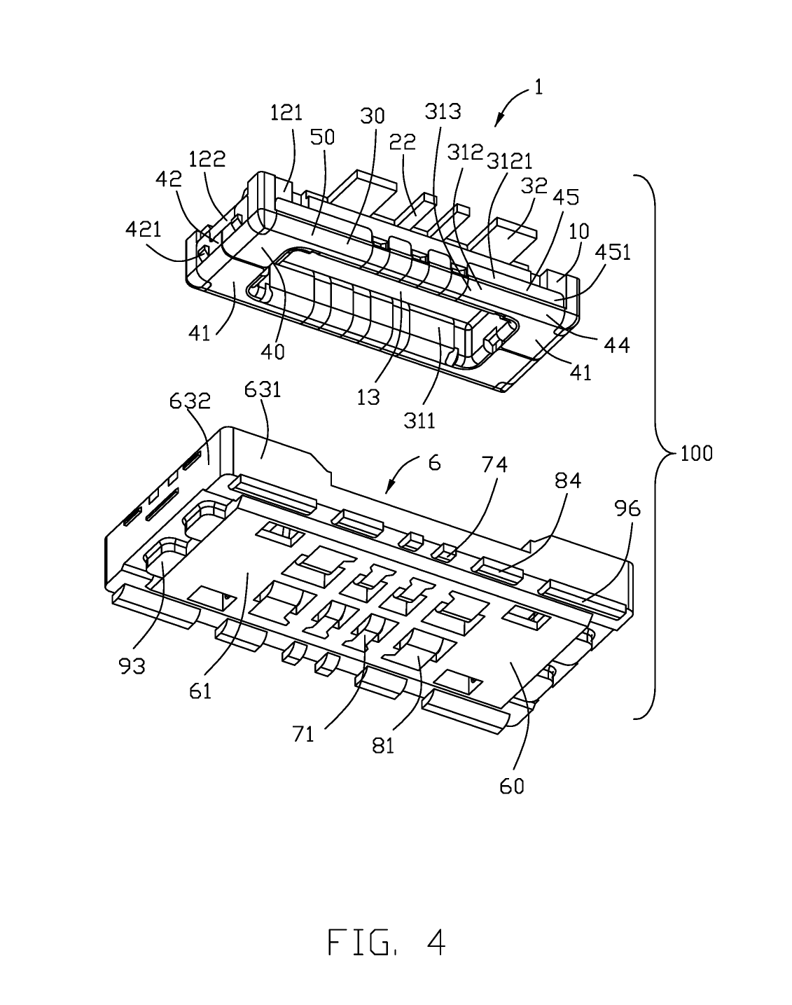

Referring to FIGS. 1-4, an electrical connector assembly 100 includes a plug connector 1 and a mating receptacle connector 6.

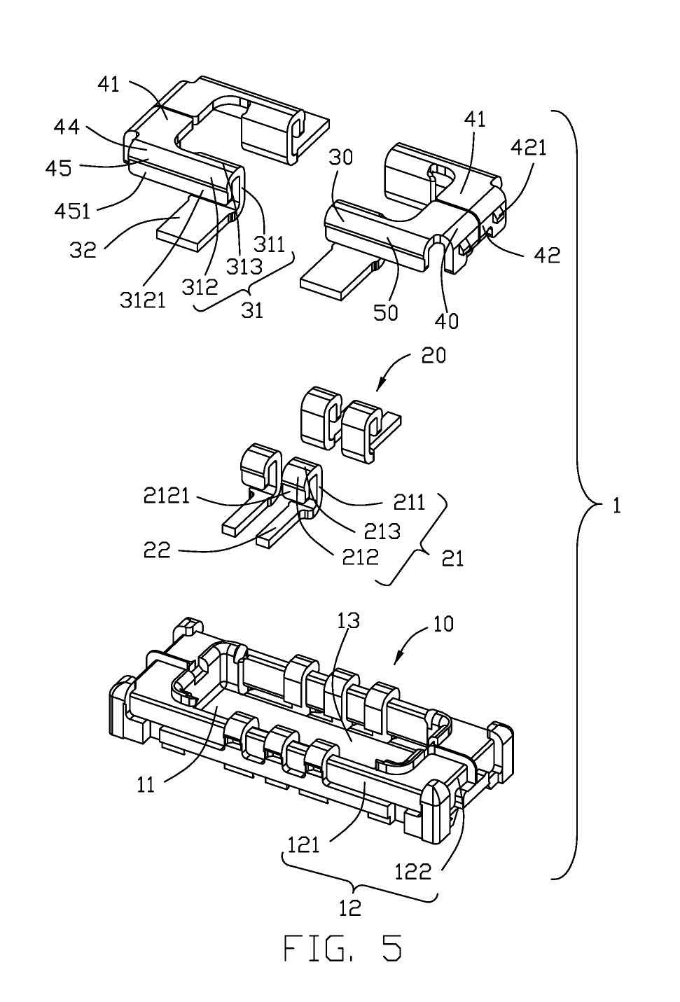

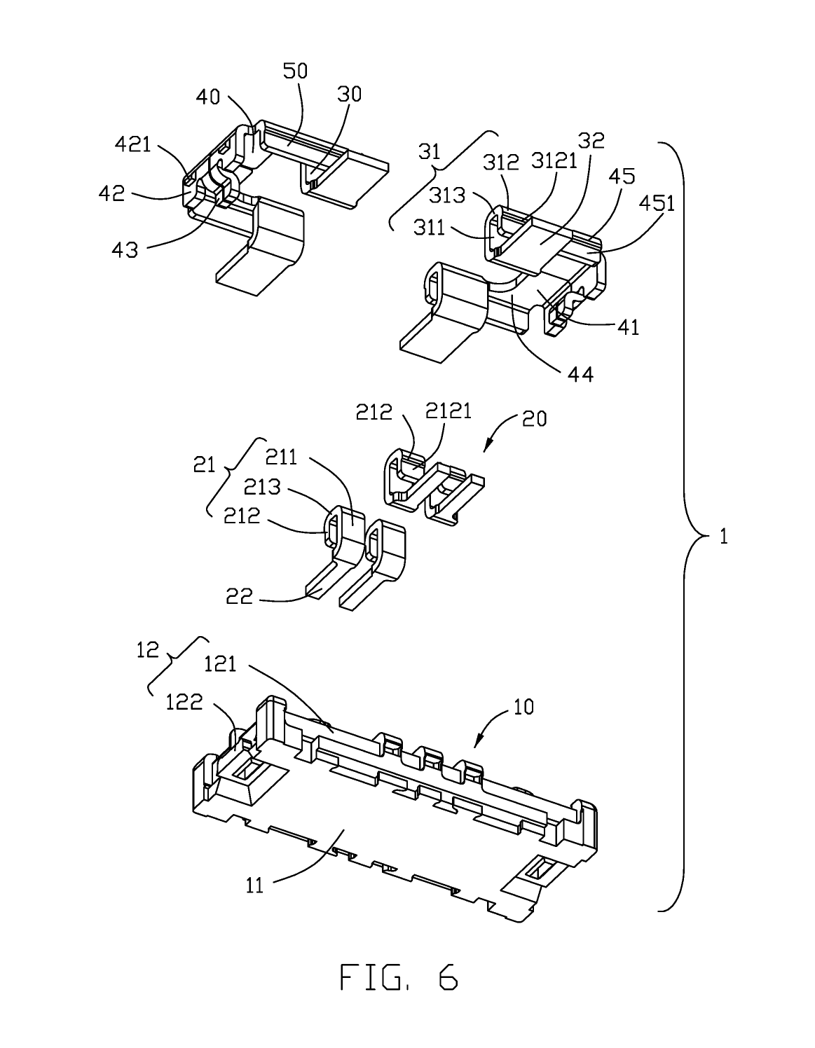

Referring to FIGS. 1-6, the plug connector 1 includes an elongate insulative housing 10, a plurality of signal contacts 20 and a pair of power contacts 30 secured (e.g., insert molded) to the insulative housing, and a pair of holding members 40 secured to two opposite ends of the insulative housing, wherein the pair of holding members are connected to the pair of power contacts by a pair of connecting portions 50.

The insulative housing 10 has a bottom wall 11 and a peripheral wall 12. The peripheral wall 12 has a pair of side walls 121 along a lengthwise direction and a pair of end walls 122 along a widthwise direction. The insulative housing 10 therefore defines a receiving space 13.

Each of the signal contacts 20 has a generally U-shaped part 21 and a soldering part 22. The U-shaped part 21 includes an inner portion 211, an outer portion 212, and an upper portion 213. The outer portion 212 has a step 2121. The inner portion 211 is exposed to the receiving space 13 and the outer portion 212 is exposed to an outside.

Each of the pair of power contacts 30 is similarly structured as the sign contact 20 but has a larger width. Therefore, the power contact 30 has a generally U-shaped part 31 and a soldering part 32, wherein the U-shaped part 31 includes an inner portion 311, an outer portion 312, and a connecting portion 313, the outer portion 312 has a step 3121, and the inner portion 311 is exposed to the receiving space 13 and the outer portion 312 is exposed to an outside.

Each holding member 40 includes a base 41, a securing portion 42, a fixing leg 43, a pair of joining portions 44, and a pair of outer portions 45. The securing portion 42 has a pair of protrusions 421. The outer portion 45 has a step 451.

Each connecting portion 50 is integrally connected between the joining and outer portions 44 and 45 of the holding member 40 and the upper and outer portions 313 and 312 of the power contact 30. In the embodiment shown each holding member 40 is made of two parts, though it may be a one-piece construction if desired.

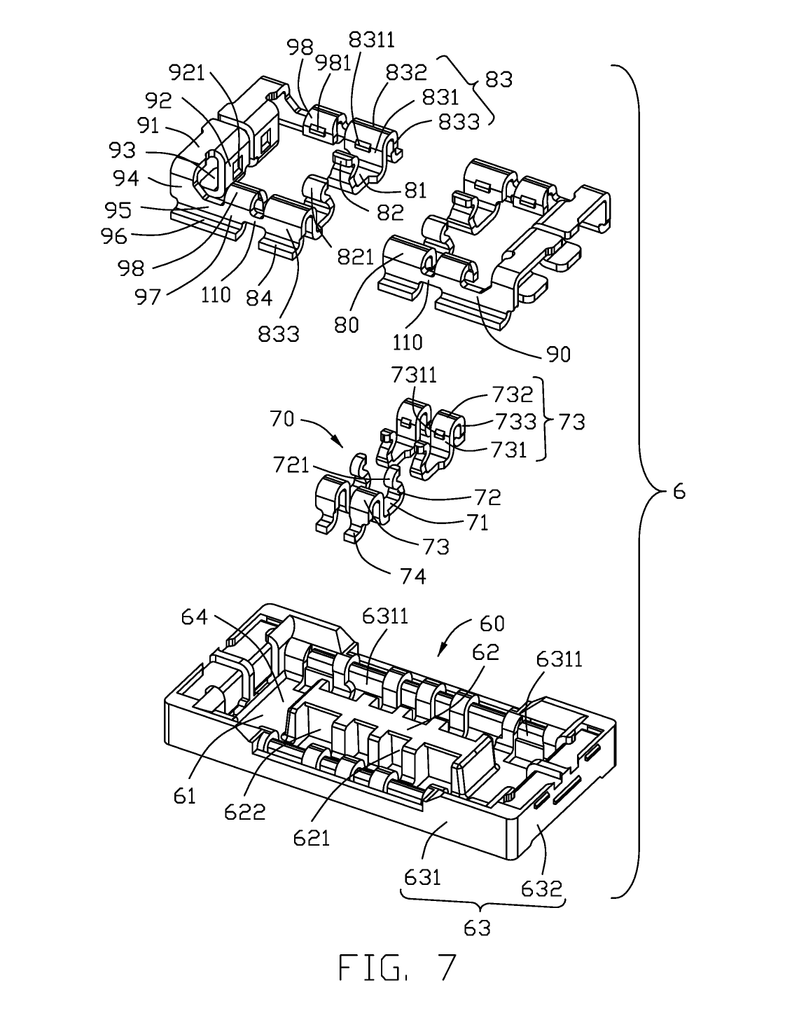

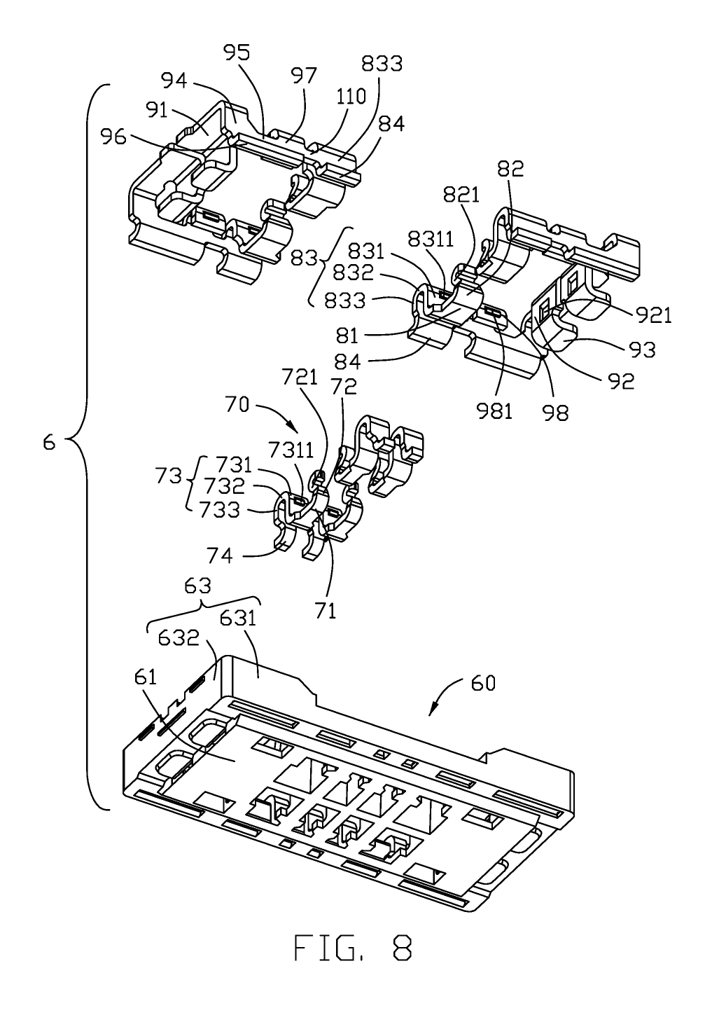

Referring to FIGS. 1-4 and 7-8, the receptacle connector 6 includes an elongate insulative housing 60, a plurality of signal contacts 70 and a pair of power contacts 80 secured (e.g., insert molded) to the insulative housing, and a pair of holding members 90 secured to two opposite ends of the insulative housing, wherein the pair of holding members are connected to the pair of power contacts by a pair of connecting portions 110.

The insulative housing 60 has a bottom wall 61, an island 62, and a peripheral wall 63. The peripheral wall 63 has a pair of side walls 631 along a lengthwise direction and a pair of end walls 632 along a widthwise direction. The insulative housing 10 therefore defines a receiving space 64. The island 62 has grooves 621 and 622. The side walls 631 have grooves 6311.

Each of the signal contacts 70 has a base 71, an arm 72, a generally U-shaped securing part 73, and a soldering part 74. The arm 72 is S-shaped and has a portion 721. The securing part 73 includes an inner portion 731, an outer portion 733, and an upper portion 732. The inner portion 731 has a protrusion 7311. The inner portion 731 is exposed to the receiving space 64.

Each of the pair of power contacts 80 is similarly structured as the sign contact 70 but has a larger width. Therefore, the power contact 80 has a base 81, an arm 82, a generally U-shaped securing part 83, and a soldering part 84, wherein the arm 82 is S-shaped and has a portion 821, the securing part 83 includes an inner portion 831, an outer portion 833, and an upper portion 832, and the inner portion 831 has a protrusion 8311. The inner portion 831 is exposed to the receiving space 64.

Each holding member 90 includes a base 91, a securing portion 92, a fixing leg 93, and a pair of joining portions 94, a pair of outer portions 95, a pair of legs 96, a pair of side portions 97, and a pair of latching portions 98. The latching portion 98 has a protrusion 981.

Each connecting portion 110 is integrally connected between the side portion 97 of the holding member 90 and the outer portion 833 of the power contact 80. In the embodiment shown each holding member 90 is made of two parts, though it may be a one-piece construction if desired.

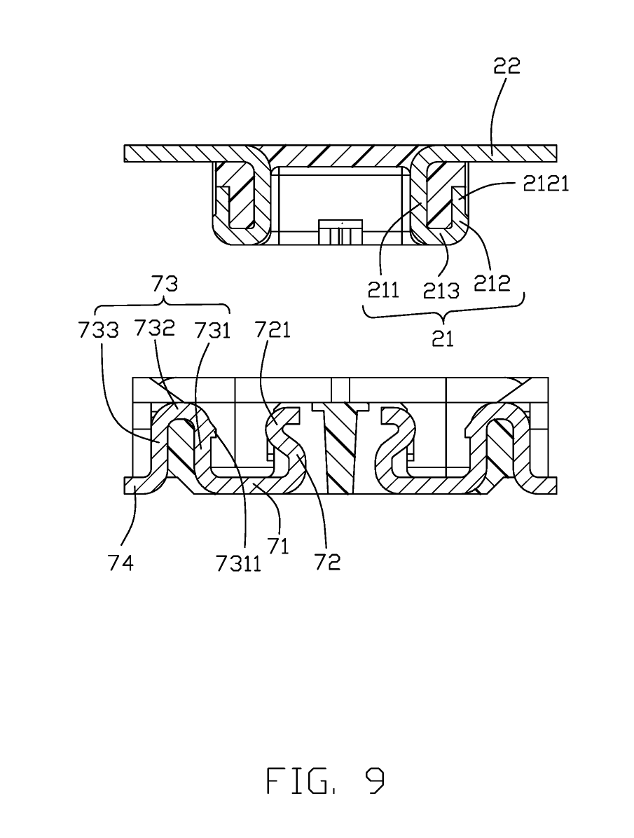

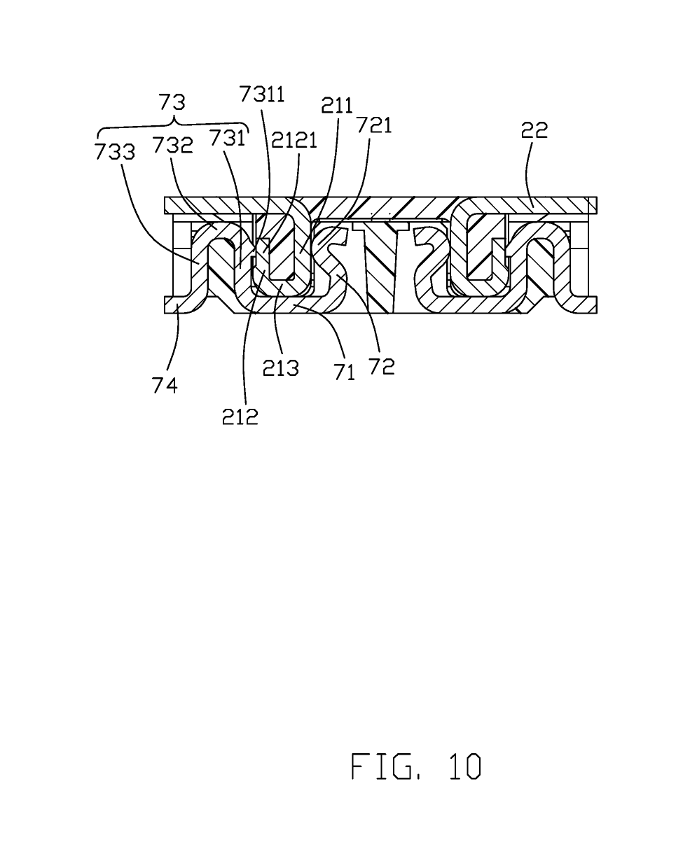

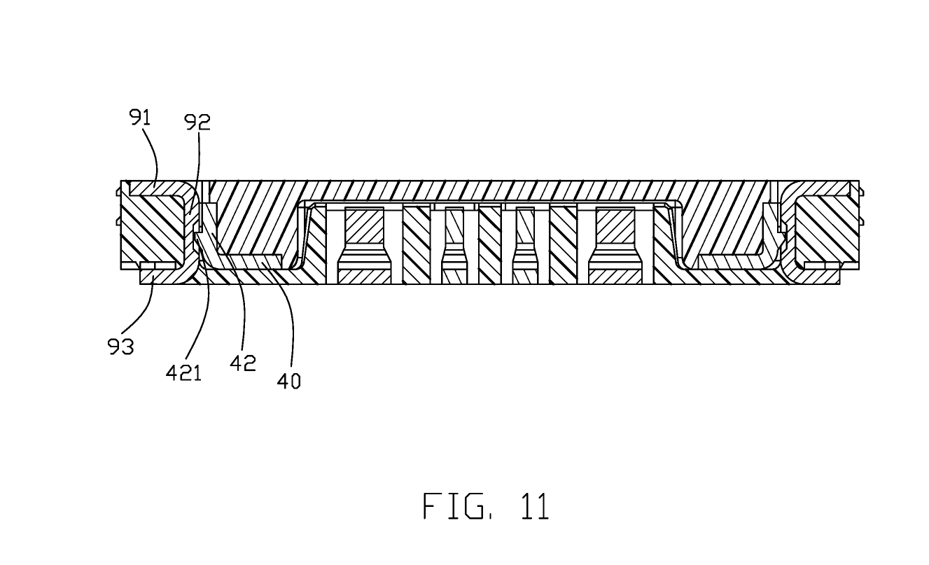

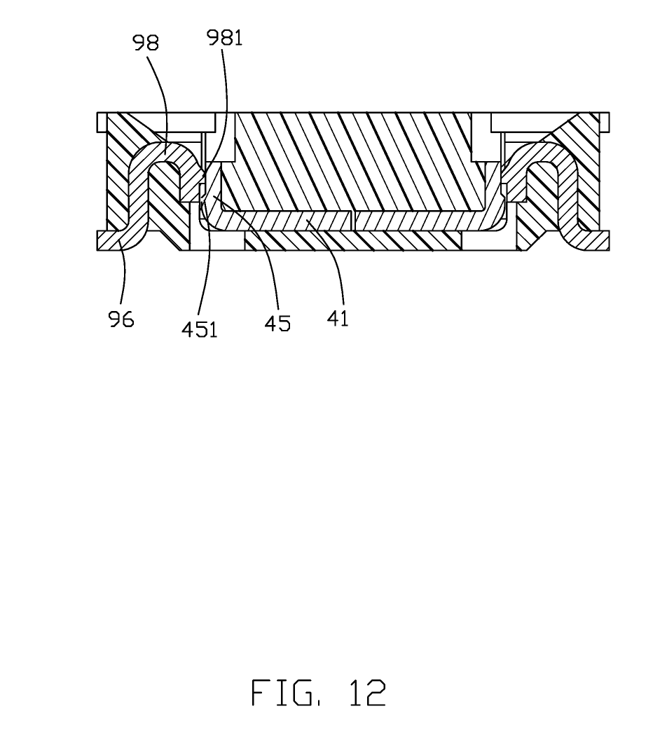

Referring to FIGS. 1-4 and 9-12, the signal and power contacts 20 and 30 and the holding members 40 of the plug connector 1 are correspondingly engaged with the signal and power contacts 70 and 80 and the holding members 90 of the receptacle connector 6, respectively, in a generally known manner in this art.

With provision of the connecting portions 50 or 110 to integrally connect the holding member to adjacent power contacts, an interconnected structure to decrease temperature rise in conducting large current may be obtained.

What is claimed is:

1. An electrical connector comprising:
an insulative housing defining a receiving space;
a plurality of signal contacts secured to the insulative housing and exposed to the receiving space;
a pair of holding members secured to two opposite ends of the insulative housing and exposed to the receiving space, each holding member having a base and a pair of arms bent from the base; and
a plurality of power contacts secured to the insulative housing, exposed to the receiving space, and disposed adjacent to the pair of holding members, wherein
the pair of holding members act as power contacts, and
the pair of arms of each holding member are integrally connected to adjacent power contacts.
